(19) United States
(12) Patent Application Publication
(10) Pub. No.: US 2026/0247340 A1
(43) Pub. Date: Aug. 20, 2026

(54) METHOD AND APPARATUS FOR INTEGRITY FOR RAT DEPENDENT POSITION TECHNIQUES

(71) Applicant: Apple Inc., Cupertino, CA (US)

(72) Inventors: Oghenekome OTERI, San Diego, CA (US); Zhibin WU, Los Altos, CA (US); Wei ZENG, Saratoga, CA (US); Haitong SUN, Saratoga, CA (US); Dawei ZHANG, Saratoga, CA (US); Alexander SIROTKIN, Hod HaSharon (IL); Haijing HU, Los Gatos, CA (US)

(21) Appl. No.: 19/156,322

(22) PCT Filed: Feb. 14, 2024
(86) PCT No.: PCT/US2024/015720

§ 371 Date: Aug. 13, 2025

Related U.S. Application Data
(60) Provisional application No. 63/445,623, filed on Feb. 14, 2023.

(51) Int. Cl. H04W 64/00

(52) U.S. Cl. CPC H04W 64/006

(57) ABSTRACT

Embodiments relate to a method and apparatus for integrity for radio access technology (RAT) dependent position techniques. In particular, embodiments relate to specifying error modelling parameters, signalling, and procedures to support UE-based and location management function (LMF)-based integrity of RATdependent positioning methods. In one embodiment, a method to implement a position integrity operation for a user equipment (UE) in a radio access network (RAN) and a core network is disclosed comprising: determining a position integrity estimation of the UE at the UE; or determining a position integrity estimation of the UE at a location management function (LMF) of the core network, wherein, based upon the determined position integrity estimation at the UE and/or at the LMF, the position integrity of the UE is determined.

### CROSS-REFERENCE TO RELATED APPLICATIONS

This application claims the benefit of and priority to U.S. Provisional Patent Application No. 63/445,623 filed Feb. 14, 2023. The entirety of which is incorporated herein by reference.

### FIELD OF INVENTION

This invention relates generally to the field of wireless communication, and more particularly, to a method and apparatus for integrity for radio access technology (RAT) dependent position techniques.

### BACKGROUND OF THE INVENTION

In a wireless communications network, a user equipment (UE) may communicate with a base station of the network by establishing a radio link between the UE and the base station. In a 5G (New Radio or NR) or 4G (LTE) wireless network, a UE may receive signaling and data from the serving base station in a downlink (DL) transmission direction or transmit signaling and data to the serving base station in an uplink (UL) transmission direction.

As part of wireless technology, global navigation satellite system (GNSS) positioning has become critical to the ability of mobile devices (e.g., UEs) to know where they are—from airplanes, drones and vehicles to smartphones and IoT devices. Positioning integrity and accuracy is an important part of Global Navigation Satellite System (GNSS) positioning. GNSS positioning refers to the use of time-of-arrival measurements from multiple satellite signals to establish distance estimates to the satellites that enable all types of mobile devices to position themselves. The most efficient way to compensate for inevitable errors in the distance estimates provided by the satellites is with the help of data from terrestrial GNSS reference stations at known locations. Such data is processed in order to provide assistance data suitable for each device in consideration of its specific situation. It is important that the mobile devices can properly assess positioning uncertainty and relate it to safety margins to ensure trust by enabling devices to indicate when reliable positioning is available or not available. This is known as positioning integrity.

Various standards releases have proposed ways to increase position integrity determinations for mobile devices. For example, in Release 17 (Rel-17), Rel-17 specifies the use of positioning integrity to ensure that use cases can properly assess trust and availability of reliable positioning, in order, to avoid situations that could lead to injury or other negative consequences due to inaccurate positioning. GNSS integrity is defined as the measure of trust that can be placed in the correctness of the information supplied by the navigation system. An application with GNSS integrity functionality can configure three requirement attributes that enable integrity assessments based on information about the position error distribution: Alert Limit (AL)—the maximum position error allowed by the application; Integrity Risk (IR)—the probability that the position error is larger than the alert limit without an alarm being triggered; Time To Alert (TTA)—the amount of time during which the position error can be higher than the alert limit before an alarm is triggered. The position estimating entity gathers all information about the positioning errors and compares it to the integrity risk to determine the Protection Level (PL)—the distance within which the true position is contained with a probability of (1-IR) (Integrity Risk).

In the Release 18 (Rel-18) positioning standards, the following objectives of the study on solutions for integrity for RAT-dependent positioning techniques are listed in the study item descriptions (SIDs): Study solutions for Integrity for RAT dependent positioning techniques: Identify the error sources; Study methodologies, procedures, signalling, etc., for determination of positioning integrity for both UE-based and UE-assisted positioning; Focus on reuse of concepts and principles being developed for RAT-Independent GNSS positioning integrity, where possible.

In the Work Items for Release 18 (Rel-18) positioning, the following objectives have been captured in work item descriptions (WIDs):—Specify error modelling parameters, signalling, and procedures to support UE-based and location management function (LMF)-based integrity of RAT-dependent positioning methods. Both UE-based and LMF-based integrity for RAT-Dependent Positioning Techniques are recommended for normative work. For UE-based positioning integrity mode, potential specification impacts related to errors in assistance data (e.g., related to inter-TRP synchronization error and TRP locations) include at least the enhancements to assistance data from the LMF to the UE (e.g., inclusion of parameters related to the error sources). Signaling design of both UE-based and LMF-based integrity can be supported.

In the Work Items for Release 18 (Rel-18) positioning, various conclusions were made. RAN1 could not reach consensus on whether beam information (NR-TRP-BeamAntennaInfo) and boresight direction of DL PRS (NR-DL-PRS-BeamInfo) are error sources or not for DL-AoD for UE-based positioning integrity mode. At least DL-PRS RSRPP of the first path or RSRP is an error source for DL-AoD for LMF-based positioning integrity mode. RAN1 could not determine the model of the error source. For LMF-based positioning integrity mode, for DL-TDOA, DL-AoD, UL-TDOA, UL-AoA and multi-RTT, the following distributions were identified as candidates for modeling the distribution of TRP location (e.g., Geographical Coordinates in TS 38.455) error: Uniform distribution or Normal distribution. It was noted that it is up to RAN2 as to how to use the identified distributions. For LMF-based positioning integrity mode, for UL-AoA, the following distributions are identified as candidates for modeling the distribution of ARP location (e.g., ARPLocationInformation in TS 38.455) error: Uniform distribution; or Normal distribution. It was noted that it is up to RAN2 as to how to use the identified distributions.

### SUMMARY OF THE DESCRIPTION

Embodiments relate to a method and apparatus for integrity for radio access technology (RAT) dependent position techniques. Based upon the work items of Release 18, embodiments relate to specifying error modelling parameters, signalling, and procedures to support UE-based and location management function (LMF)-based integrity of RAT-dependent positioning methods. In particular, based upon the work items of Release 18, to improve integrity for RAT dependent position techniques, the following solutions may be implemented: Solution 0: Updated Integrity Operation Principle; Solution 1: Integrity for UE-based Positioning Methods; Solution 2: Integrity for LMF-based Positioning Methods; Solution 3: Real Time Integrity for UE based/LMF based positioning; Solution 4: Time Duration for Integrity Alert Timing; Solution 5: Integrity Service Parameters; and Solution 6: Integrity Information Exchange and Signaling; all of which will be described in more detail hereafter.

In one example embodiment, a method to implement a position integrity operation for a user equipment (UE) in a radio access network (RAN) and a core network is disclosed that comprises: determining a position integrity estimation of the UE at the UE, or, determining a position integrity estimation of the UE at a location management function (LMF) of the core network; in which, based upon the determined position integrity estimation at the UE and/or at the LMF, the position integrity of the UE is determined.

In one embodiment, determining the position integrity estimation of the UE at the UE includes utilizing integrity requirements and assistance data from the RAN and/or LMF. In one embodiment, the assistance data from the RAN and/or LMF includes data facilitating the determination of the position integrity estimation. In one embodiment, determining the position integrity estimation of the UE at the LMF includes utilizing integrity requirements and assistance data from the UE and RAN at the LMF and the position integrity estimation is transmitted to the UE. In one embodiment, the assistance data from the UE and the RAN to the LMF includes data facilitating the determination of the position integrity estimation for the UE at the LMF.

In one embodiment, the UE or LMF receives health status information about a UE or a network component of the RAN supporting the UE or LMF in the determination of the position integrity estimation for the UE. In one embodiment, the UE or LMF in the determination of the position integrity estimation receives an integrity service alert to provide information on whether the service is useable for integrity and a Do Not Use (DNU) flag to indicate if assistance data associated with the UE or a network component of the RAN supporting the UE or LMF in the determination of the position integrity estimation for the UE is determined to not be suitable for computing position integrity, such that if the integrity service alert is issued, and the DNU flag is false, the corresponding assistance data is useable for computing position integrity. In one embodiment, the integrity service alert and the DNU flag are applicable for a specific time duration provided in a slot, sub-frame, or frame. In one embodiment, assistance data values are pre-defined to a default value of DNU true or false. In one embodiment, the assistance data values are pre-defined to a default value of DNU true or false and the integrity service alert switches the DNU value for a specific time duration and switches back to the default value on expiration of the specific time duration. In one embodiment, if an integrity service alert is not received, the DNU is interpreted as false, and when the DNU is received as true, the DNU is held at true until DNU false is or DNU is held at true for a valid time period included in the alert message, and after the time expires, the DNU is transferred back to false. In one embodiment, integrity service parameters provide the range of integrity risk (IR) for which associated integrity data assistance of UE and network components of the RAN is considered valid, and the integrity service parameters are transmittable from the LMF to the UE, from network components of the RAN to the LMF, and from the UE to the LMF. In one embodiment, the method further comprises that: the UE, the LMF, and a transmission/reception point (TRP) of the RAN (UE/LMG/TRP) exchanging location capability and configuration; the UE/LMG/TRP exchanging location specific integrity capability and configuration; the UE/LMG/TRP sending and/or receiving location specific integrity assistance data; performing location and integrity estimation; and performing locating and integrity signaling and alerts.

In another type of embodiment, a user equipment (UE) to implement a position integrity operation for the UE, the UE in connection with a radio access network (RAN) and a core network including a location management function (LMF), is disclosed. The UE comprises: at least one antenna; at least one radio, wherein the at least one radio is configured to communicate with the RAN including a base station and the core network using the at least one antenna; and at least one processor coupled to the at least one radio, wherein the at least one processor is configured to perform operations comprising: determining a position integrity estimation of the UE at the UE, based upon a determined position integrity estimation at the UE and/or at the LMF. In one embodiment, determining the position integrity estimation of the UE at the UE includes utilizing integrity requirements and assistance data from the RAN and/or LMF. In one embodiment, the assistance data from the RAN and/or LMF includes data facilitating the determination of the position integrity estimation.

In one embodiment, the UE or LMF receives health status information about a UE or a network component of the RAN supporting the UE or LMF in the determination of the position integrity estimation for the UE. In one embodiment, the UE or LMF in the determination of the position integrity estimation receives an integrity service alert to provide information on whether the service is useable for integrity and a Do Not Use (DNU) flag to indicate if assistance data associated with the UE or a network component of the RAN supporting the UE or LMF in the determination of the position integrity estimation for the UE is determined to not be suitable for computing position integrity, such that if the integrity service alert is issued, and the DNU flag is false, the corresponding assistance data is useable for computing position integrity. In one embodiment, the integrity service alert and the DNU flag are applicable for a specific time duration provided in a slot, sub-frame, or frame. In one embodiment, assistance data values are pre-defined to a default value of DNU true or false. In one embodiment, the assistance data values are pre-defined to a default value of DNU true or false and the integrity service alert switches the DNU value for a specific time duration and switches back to the default value on expiration of the specific time duration. In one embodiment, if an integrity service alert is not received, the DNU is interpreted as false, and when the DNU is received as true, the DNU is held at true until DNU false is or DNU is held at true for a valid time period included in the alert message, and after the time expires, the DNU is transferred back to false. In one embodiment, integrity service parameters provide the range of integrity risk (IR) for which associated integrity data assistance of UE and network components of the RAN is considered valid, and the integrity service parameters are transmittable from the LMF to the UE, from network components of the RAN to the LMF, and from the UE to the LMF.

In yet another type of embodiment, a location management function (LMF) system in a core network to implement a position integrity operation for a user equipment (UE) connected to radio access network (RAN) is disclosed that comprises: an interface to send and receive data; and a processor coupled to the interface, the processor to perform operations comprising: determining a position integrity estimation of the UE; and sending the determined position integrity estimation of UE to the UE. In one embodiment, determining the position integrity estimation of the UE at the LMF includes utilizing integrity requirements and assistance data from the UE and RAN at the LMF and the position integrity estimation is transmitted to the UE. In one embodiment, the assistance data from the UE and the RAN to the LMF includes data facilitating the determination of the position integrity estimation for the UE at the LMF.

In one embodiment, the UE or LMF receives health status information about a UE or a network component of the RAN supporting the UE or LMF in the determination of the position integrity estimation for the UE. In one embodiment, the UE or LMF in the determination of the position integrity estimation receives an integrity service alert to provide information on whether the service is useable for integrity and a Do Not Use (DNU) flag to indicate if assistance data associated with the UE or a network component of the RAN supporting the UE or LMF in the determination of the position integrity estimation for the UE is determined to not be suitable for computing position integrity, such that if the integrity service alert is issued, and the DNU flag is false, the corresponding assistance data is useable for computing position integrity. In one embodiment, the integrity service alert and the DNU flag are applicable for a specific time duration provided in a slot, sub-frame, or frame. In one embodiment, assistance data values are pre-defined to a default value of DNU true or false. In one embodiment, the assistance data values are pre-defined to a default value of DNU true or false and the integrity service alert switches the DNU value for a specific time duration and switches back to the default value on expiration of the specific time duration. In one embodiment, if an integrity service alert is not received, the DNU is interpreted as false, and when the DNU is received as true, the DNU is held at true until DNU false is or DNU is held at true for a valid time period included in the alert message, and after the time expires, the DNU is transferred back to false. In one embodiment, integrity service parameters provide the range of integrity risk (IR) for which associated integrity data assistance of UE and network components of the RAN is considered valid, and the integrity service parameters are transmittable from the LMF to the UE, from network components of the RAN to the LMF, and from the UE to the LMF.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one embodiment of the disclosure.

FIG. 2 illustrates user equipment in direct communication with a base station (BS) according to one embodiment of the disclosure.

FIG. 3 illustrates an example block diagram of a UE according to one embodiment of the disclosure.

FIG. 4 illustrates an example block diagram of a BS according to one embodiment of the disclosure.

FIG. 5 illustrates an example block diagram of cellular communication circuitry according to one embodiment of the disclosure.

FIG. 6 illustrates a flow diagram of a process to implement a position integrity operation for a user equipment (UE) in a radio access network (RAN) and network according to one embodiment of the disclosure.

FIG. 7 shows a block diagram of a wireless communication system according to one embodiment of the disclosure.

FIG. 8 shows a block diagram illustrating various solutions for a time duration for integrity alert timing according to one embodiment of the disclosure.

FIG. 9 is a flow diagram is shown illustrating a process for integrity information exchange and signaling according to one embodiment of the disclosure.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

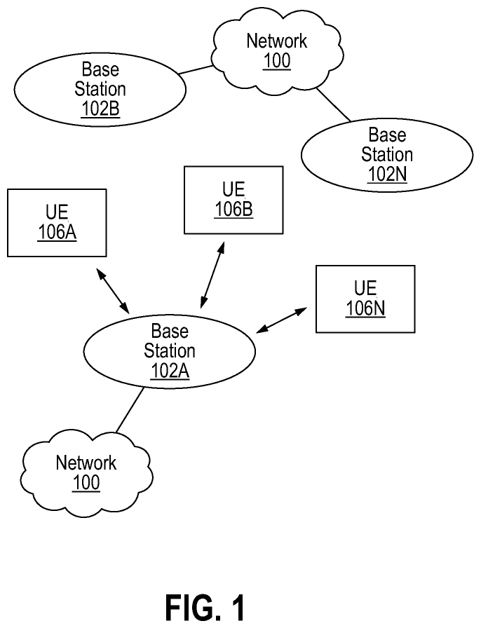

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

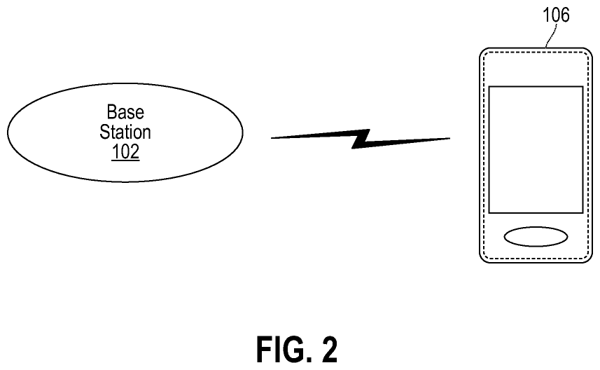

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

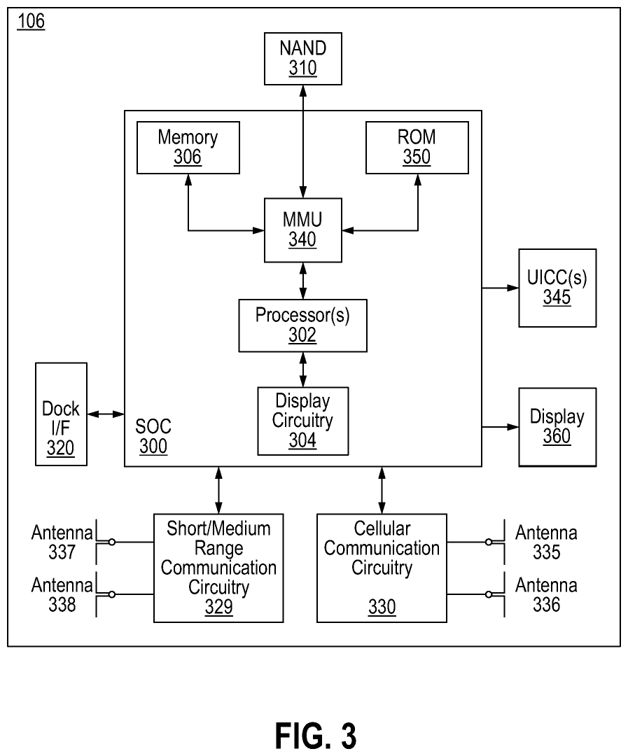

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively, (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

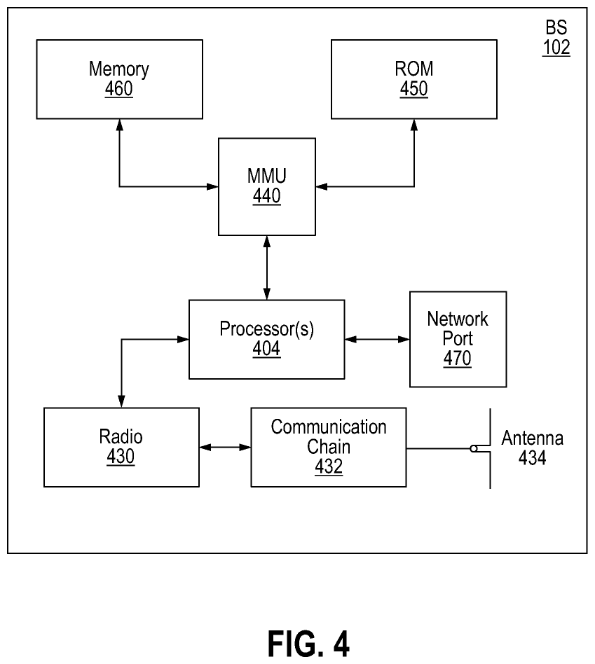

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 ofthe base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

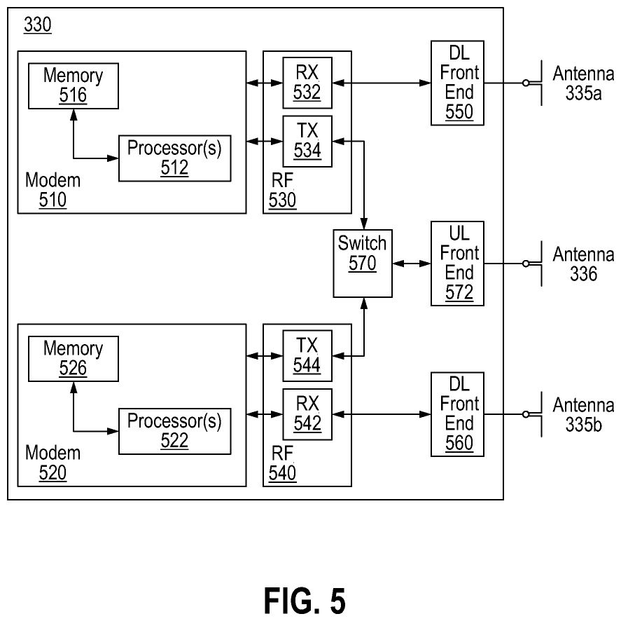

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

Embodiments of the invention relate generally to the field of wireless communication, and more particularly, to a method and apparatus for integrity for radio access technology (RAT) dependent position techniques. Further, based upon the work items of Release 18, embodiments relate to specifying error modelling parameters, signalling, and procedures to support UE-based and location management function (LMF)-based integrity of RAT-dependent positioning methods.

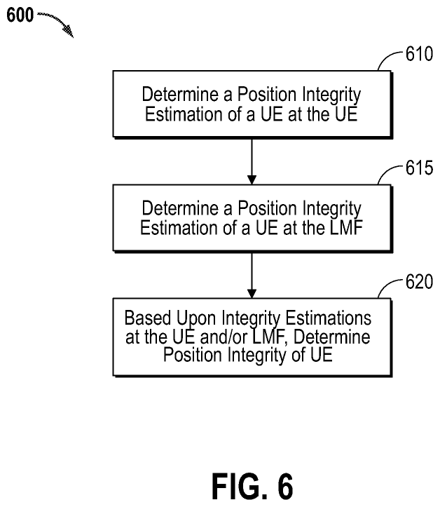

With reference to FIG. 6, FIG. 6 shows a flow diagram of a process 600 to implement a position integrity operation for a user equipment (UE) in a radio access network (RAN) and core network. The process 600 includes: determining a position integrity estimation of the UE at the UE (block 610) or determining a position integrity estimation of the UE at a location management function (LMF) of the core network (block 615). Further, based upon the determined position integrity estimation at the UE and/or at the LMF, the position integrity of the UE is determined (block 620).

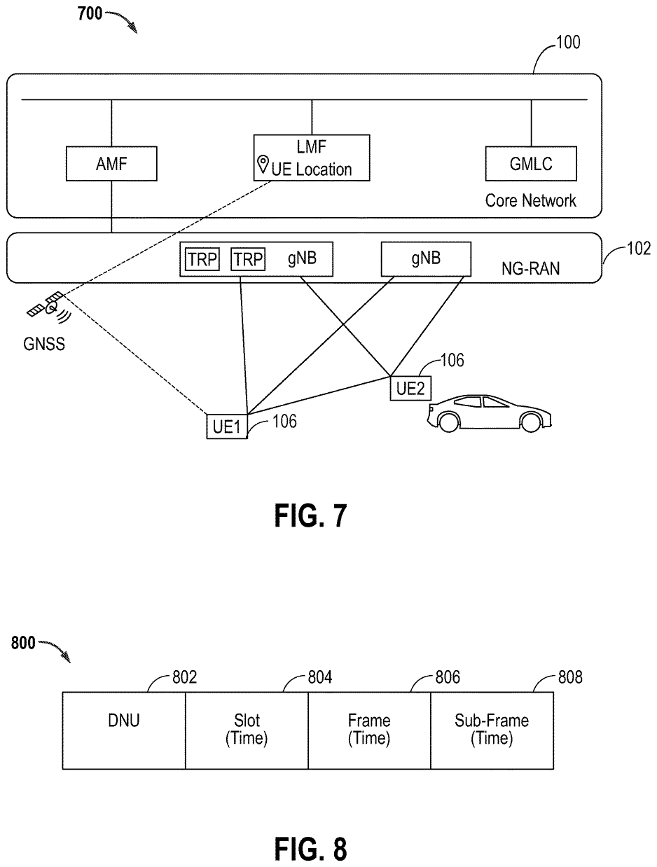

With brief additional reference to FIG. 7, FIG. 7 shows a block diagram of a 700 of a wireless communication system, which focuses on some more particular aspects of FIG. 1, in which, a position integrity operation for a user equipment (UE) 106 in a radio access network (RAN) and network 700, can be implemented. FIG. 7 is briefly used to focus on some more particular aspects of FIG. 1.

FIG. 7 illustrates a simplified example wireless communication system according to one aspect of the disclosure. FIG. 7, as in FIG. 1, shows UEs 106. As an example, the UEs 106 may be mobile devices, such that, position integrity determinations are needed to be made. As an example, a first UE1 106 may be a cell phone and a second UE 106 may be a car and a third UE 106 may be a robot. It should be appreciated that any UE that has position integrity determinations may be utilized in aspects of the disclosure. As in FIG. 1, the core network 100 is further defined to include an Access & Mobility Management Function (AMF), a Location Management Function (LMF) also in communication with a Global Navigation Satellite Systems (GNSS), and a Gateway Mobile Location Centre (GMLC). The LMF is generally defined as enabling lawful mediation platforms to attach precise location information to devices used in intercepted communications in real time. The AMF is generally defined as a control plane function in the core network that handles connection and management mobility tasks. The GMLC is generally defined as containing functionality required to support location-based service (LBS). The base station 102 is further defined to be a Next Generation Radio Access Network (NG-RAN) that is a gNB and that includes transmission/reception points (TRPs). In this example, the base station 102 NG-RAN wireless communicates with UEs 106, in cooperation with the core network 100, and GNSS, to wirelessly communicate information, as previously described, and as will be described, in aspects of the disclosure, perform position estimation, and determine position integrity estimations. However, it should be appreciated that embodiments of the disclosure may be implemented with any suitable wireless communication system.

As previously described embodiments of the disclosure relate to: determining a position integrity estimation of the UE at the UE and/or determining a position integrity estimation of the UE at a location management function (LMF) of the core network. Further, based upon the determined position integrity estimation at the UE and/or at the LMF, the position integrity of the UE is determined.

As has been described, in the Work Items for Release 18 (Rel-18) positioning, the following objectives have been captured in work item descriptions (WIDs):—Specify error modelling parameters, signalling, and procedures to support UE-based and location management function (LMF)-based integrity of RAT-dependent positioning methods. Both UE-based and LMF-based integrity for RAT-Dependent Positioning Techniques are recommended for normative work. For UE-based positioning integrity mode, potential specification impacts related to errors in assistance data (e.g., related to inter-TRP synchronization error and TRP locations) include at least the enhancements to assistance data from the LMF to the UE (e.g., inclusion of parameters related to the error sources). Signaling design of both UE-based and LMF-based integrity can be supported.

Based upon the work items of Release 18, to improve integrity for RAT dependent position techniques, the following solutions may be implemented: Solution 0: Updated Integrity Operation Principle; Solution 1: Integrity for UE-based Positioning Methods; Solution 2: Integrity for LMF-based Positioning Methods; Solution 3: Real Time Integrity for UE based/LMF based positioning; Solution 4: Time Duration for Integrity Alert Timing; Solution 5: Integrity Service Parameters; and Solution 6: Integrity Information Exchange and Signaling; all of which will be described in more detail hereafter.

To begin with, Solution 0: an Updated Integrity Operation Principle should be utilized. In these improved embodiments, similar to GNSS integrity, the UE/TRP or LMF will perform the integrity operation as P(Error >Bound for longer than TTA| NOT DNU)<=Residual Risk+IRallocation−for all values of IRallocation in the range irMinimum<=IRallocation<=irMaximum. (IR relates to Integrity Risk). This is defined in Equation 8.1.1a-1 of Technical Specification (TS) 38.305 for 3GPP. The Error may be defined as: Difference between true value of a positioning parameter (e.g., TRP location), and its value as estimated and provided in the corresponding assistance data. The Bound may be defined as: Integrity Bounds provide the statistical distribution of the residual errors associated with the positioning method. The Time-to-Alert (TTA) may be defined as: Maximum allowable elapsed time from when Error exceeds the Bound until a DNU flag must be issued.

Do Not Use (DNU) flags may be defined as: DNU flag(s) correspond to a particular error as follows—Where multiple DNU flags are specified, the DNU condition in Equation 8.1.1a-1 is present when any of the flags are true (logical OR of the flags). Residual Risk may be defined as: the Probability of Onset which is defined per unit of time and represents the probability that the feared event begins. Each Residual Risk is accompanied by a Mean Duration which represents the expected mean duration of the corresponding feared event and is used to convert the Probability of Onset to a probability that the feared event is present at any given time: P(Feared Event is Present)=Mean Duration*Probability of Onset of Feared Event. irMinimum, irMaximum may be defined as: Minimum and maximum allowable values of IRallocation that may be chosen by the client (e.g., owner or entity in charge defining components for position estimation and integrity). These may be provided as service parameters from the network according to integrity service parameters.

As will described hereafter, embodiments of the disclosure update the parameters of this equation for improved RAT dependent positioning techniques for position integrity. In particular, unit time is updated. Unit Time: is updated from epoch (in GNSS) to time suitable for the terrestrial network. As an example option, unit time may be: pre-configured, pre-defined, etc. (e.g. as a frame, sub-frame, etc.), as will be described. Further, irMinimum, irMaximum is updated, such that, values may be chosen by the client (e.g., owner or entity in charge of defining components for position estimation and integrity). For example, the client may be UE 106 (for UE based positioning) or LMF (for network-based positioning) in the core network 100. Furthermore, Do Not Use (DNU) flags may be updated. The DNU flag(s) may correspond to a particular error based on: (a) the type of positioning and (b) the type of error, as will be described.

In one embodiment, a Solution 1 is set forth related to Integrity for UE-based Positioning Methods. In this embodiment, in a first option, integrity estimation may occur at the UE 106. UE 106 uses integrity requirements and assistance data from NG-RAN 102/LMF 100 to determine integrity results of the calculated location. For example, the assistance data signaled to the UE includes data facilitating the integrity results determination of the calculated location. This depends upon the specific UE-based positioning method. As to information transfer, assistance data may be transmitted from the LMF 100 to the UE 106 (via e.g., LTE position protocol (LPP)(. Assistance data can be transmitted from the gNB 102 to the LMF (via e.g., NR positioning protocol A (NRPPa)) then from LMF to UE (via LPP). Further, the DNU is sent to UE via LPP. The various types of assistance data that can be transmitted to the UE 106, will be described in detail hereafter.

The current standard that indicates the information needed for UE-based position integrity mode below may be used as a baseline:

| Positioning Integrity | | |
|---|---|---|
| Mode | DL TDOA | DL AoD |
| UE-based (as defined | TRP location (e.g., NR-TRP- | TRP location (e.g., NR- |
| in Table 9.4.1.1.1 in | LocationInfo in TS 37.355 [16]) | TRP-LocationInfo in TS |
| TR 38.857 [2]) | Inter-TRP synchronization (e.g., NR- | 37.355 [16]) |
| | RTD-Info in TS 37.355 [16]) | |

In a second option, integrity estimation may occur at the LMF 100 and then integrity results may be transmitted to UE 106. LMF uses integrity requirements and assistance data from UE 106/NG-RAN 102 to determine possible integrity results of integrity risk of the positioning method if it is used to calculate a location on the UE side. For example, LMF 100 transmits integrity values to UE 106. Alternatively, LMF transmits a DNU_location for location estimate to UE. The assistance data from the UE to the LMF includes: data facilitating the integrity results determination of the calculated location; and depends on the specific UE-based positioning method. As to information transfer: Assistance data is transmitted from the UE to the LMF via LPP; Assistance data is transmitted from the gNB to LMF (via NRPPa); and DNU_location is sent to the UE via LPP. The various types of assistance data that can be transmitted to the LMF 100, will be described in detail hereafter. The current standard that indicates the information needed for UE-based position integrity mode previously described may be used as a baseline.

In one embodiment, a Solution 2 is set forth related to Integrity for LMF-based Positioning Methods. In a first option, integrity estimation may occur at the LMF 100 and then integrity results may be transmitted to UE 106. LMF uses integrity requirements and assistance data from UE 106/NG-RAN 102 to determine possible integrity results of the calculated location. For example, LMF 100 transmits integrity values to UE 106. Alternatively, LMF transmits a DNU_location for location estimate to UE. The assistance data signaled to the UE includes: data facilitating the integrity results determination of the calculated location; and depends on the specific LMF-based positioning method. As to information transfer: Assistance data is transmitted from the UE to the LMF via LPP; Assistance data is transmitted from the gNB to LMF (via NRPPa); and DNU_values may be generated locally or at the device generating the assistance data. The various types of assistance data that can be transmitted to the LMF 100, will be described in detail hereafter. The current standard that indicates the information needed for LMF-based position integrity mode below may be used as a baseline:

| Positioning | | | | | |
|---|---|---|---|---|---|
| Integrity | | | | | |
| Mode | DL TDOA | UL TDOA | Multi-RTT | UL AoA | DL AoD |
| LMF-based | RSTD | RTOA | UE Rx − Tx | Angle of arrival | TRP location |
| (as defined | measurement | measurement | time | measurement | DL-PRS |
| in Table | TRP location | TRP location | difference | TRP location | RSRPP of |
| 9.4.1.1.1 in | Inter-TRP | Inter-TRP | measurement | ARP location (e.g., | the first |
| TR 38.857 | synchronization | synchronization | gNB Rx − Tx | ARPLocationInformation | path or |
| [2]) | (can be caused | (can be caused | time | in TS 38.455 [17]) | RSRP |
| | in part by | in part by | difference | | |
| | errors in SFN | errors in SFN | measurement | | |
| | initialization | initialization | TRP location | | |
| | time.) | time.) | | | |

In a second option, integrity estimation may occur at the UE 106. UE 106 uses integrity requirements and assistance data from NG-RAN 102/LMF 100 to determine integrity results of the calculated location. For example, the assistance data signaled to the UE includes data facilitating the integrity results determination of the calculated location. This depends upon the specific LMF-based positioning method. As to information transfer, assistance data may be transmitted from the LMF 100 to the UE 106 via LTE position protocol (LPP). Assistance data can be transmitted from the gNB 102 to the LMF (via e.g., NR positioning protocol A (NRPPa)) then from LMF to UE (via LPP). Further, the DNU is sent to UE via LPP. The various types of assistance data that can be transmitted to the UE 106, will be described in detail hereafter. The current standard that indicates the information needed for LMF-based position integrity mode previously described may be used as a baseline.

In one embodiment, a Solution 3 is set forth related to real-time integrity for UE-based and LMF-based positioning. One problem issue that arises for GNSS integrity, is that the Real Time Integrity definition (as set forth in Technical Specification (TS) 38.305 for 3GPP (8.1.2.1.8)) provides the GNSS receiver with information about the health status of a GNSS constellation (where the specific GNSS is indicated by a GNSS ID). This definition needs to be updated for a terrestrial networks. This definition needs to be updated.

In one embodiment, a Definition 1 is disclosed, in which, Real-Time Integrity assistance provides the UE 106/LMF 100 with information about the health status of a supporting UE 106/TRP 102/Antenna Reference Point (ARP). For example, measurements and/or signals from a UE/TRP/ARP that are to be used for the positioning location estimate. It should be noted that this may support sidelink positioning (e.g., in the case of PC5/Uu positioning). In this case, the real-time signal indication of a bad signal can be transferred from one UE to another UE. PC5 may refer to a reference point where the User Equipment (UE) directly communicates with another UE over the direct channel. Further, the real-time signal indication of a bad signal can be transferred from LMF to UE (for UE-based positioning) or from UE/TRP to LMF (for LMF/network-based positioning)

In one embodiment, a Definition 2 is disclosed, in which, for integrity purposes, a supporting UE 106/TRP 102/ARP (and/or specific measurements) should be considered as being marked “Do Not Use” (DNU) if: Option 1: a “Do Not Use” (DNU) is signaled; or Option 2: a UE ID/TRP index/ARP index is present in the list of unhealthy (bad) signals—in which case all associated signals (or signals in combination with another device) are assumed to be bad; or Option 3: a subset of the signal(s) of a UE ID/TRP index/ARP index are present in the list of unhealthy (bad) signals. It should be noted that the absence of the Real Time Integrity assistance from any Provide Assistance Data message is interpreted as DNU=FALSE for all UEs and signals that are monitored for integrity.

In another embodiment, a Solution 4 is set forth for a time duration for integrity alert timing. Integrity Service Alerts provide information on whether the service can be used for integrity. A Do Not Use (DNU) flag indicates that the corresponding assistance data is not suitable for the purpose of computing integrity. If an Integrity Service Alert is issued and the DNU flag is false, then the corresponding assistance data may be used for the purpose of computing integrity. Currently, DNU flags are defined to be applicable to the specified epoch time only for GNSS. This presents a first and second problem: Problem 1) This is applicable to a specific epoch time which is a timing definition for satellite communications only; and Problem 2) There is no present solution as to transfer directions.

With additional reference to FIG. 8, various solution options are disclosed. Option 1: Specific time durations are proposed. As a particular option, option 1-1: specific time durations can be pre-defined (e.g., in the specification), such as, slot 804, frame 806, sub-frame 808, which, can be in msec/sec time duration. As another option, option 1-1: specific time durations can be pre-configured or configured, e.g., by RRC signaling.

As yet another option, Option 2: All assistance data values can pre-defined, configured, pre-configured, etc., to a default value, e.g., DNU=True/False. As further options, Integrity Service alert values can be toggled; or an Integrity Service alert value switches value for a time duration and then switches back to default on expiration of the value.

As yet another option, Option 3: 1) If no alert is received, the DNU is interpreted as “false”; or 2) whenever a TRUE value is received, a) it holds until it receives a DNU=false, or, b) it holds for a valid period time included with the alert message itself. After this time expires, then it still means DNU=false. It should be appreciated that these values can be transferred from LMF to UE (for UE-based positioning) or from UE/TRP to LMF (for LMF/network-based positioning).

In a further embodiment, a Solution 5 is set forth for integrity service parameters. A problem exists in that current Integrity Service Parameters are defined for a GNSS network and limited to transfer to the UE 106. As a solution to this, Integrity Service Parameters can provide the range of Integrity Risk (IR) for which the associated UE/TRP/ARP integrity assistance data is considered to be valid. For example, integrity service parameter can be transferred: from LMF 100 to UE 106 (for UE-based positioning); from TRP 102 to LMF 100 (for LMF/network-based positioning); and from UE 106 to LMF 100 (for LMF/network-based positioning)

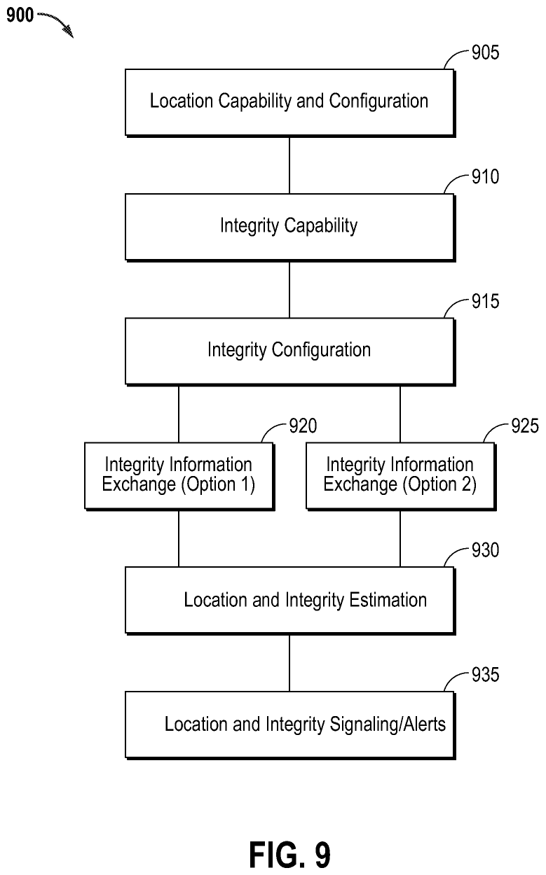

In an additional embodiment, a Solution 6 is set forth for integrity information exchange and signaling. A problem needs to be solved as to what information is exchanged and how the information is exchanged, including the information previously described, for determining position integrity. With reference also to FIG. 9, these method steps 900 will be described. At method step 905, the UE/LMF/TRP can exchange location capability and configuration. At method step 910, the UE/LMF/TRP can exchange location method specific integrity capability and configuration. At method step 915, the UE/LMF/TRP can send/receive location specific integrity assistance data. Two integrity information exchange options can be implemented in this step, Option 1 920: A subset of error sources (and distribution parameters) specific to each positioning type is added to the existing assistance data for the positioning type; and/or Option 2 925: each source (and corresponding distribution) is independently created as a separate field/information element in a dedicated integrity assistance data information transfer. Various types of assistance data will be described hereafter. At method step 930, location and integrity estimation can be performed. At method step 935, location and integrity signaling/alerts can be performed.

Below are examples of assistance data that may transferred (as part of Option 1 920) related to subsets of error sources (and distribution parameters) specific to each positioning type that are added to the existing assistance data for the positioning type. Table 8.12.2.1-1 relates to assistance data that may be transferred from LMF 100 to UE 106 (downlink-TDoA (time difference of arrival)) that can be used in the previously described integrity position methods. Table 8.12.2.2-1 relates to measurement results that may be transferred from UE 106 to LMF 100 (downlink-TDoA (time difference of arrival)) that can be used in the previously described integrity position methods. Table 8.13.2.0-1 relates to assistance data that may be transferred from gNB 102 to LMF 100 (uplink-TDoA (time difference of arrival)) that can be used in the previously described integrity position methods.

TABLE 8.12.2.1-1
Assistance data that may be transferred from LMF to the UE (DL-TDOA)

| Information | UE-assisted | UE-based |
|---|---|---|
| Physical cell IDs (PCIs), global cell IDs (GCIs), ARFCN, and PRS IDs of | Yes | Yes |
| candidate NR TRPs for measurement | | |
| Timing relative to the serving (reference) TRP of candidate NR TRPs | Yes | Yes |
| DL-PRS configuration of candidate NR TRPs | Yes | Yes |
| SSB information of the TRPs (the time/frequency occupancy of SSBs) | Yes | Yes |
| Spatial direction information (e.g. azimuth, elevation etc.) of the DL-PRS | No | Yes |
| Resources of the TRPs served by the gNB | | |
| Geographical coordinates of the TRPs served by the gNB (include a transmission | No | Yes |
| reference location for each DL-PRS Resource ID, reference location for the | | |
| transmitting antenna of the reference TRP, relative locations for transmitting | | |
| antennas of other TRPs) | | |
| Fine Timing relative to the serving (reference) TRP of candidate NR TRPs | No | Yes |
| PRS-only TP indication | Yes | Yes |
| The association information of DL-PRS resources with TRP Tx TEG ID | No | Yes |
| LOS/NLOS indicators | No | Yes |
| On-Demand DL-PRS-Configurations | Yes | Yes |
| Validity Area of the Assistance Data | Yes | Yes |
| TRP Location Error | Yes | Yes |
| Inter-TRP Synchronization Error | Yes | Yes |

TABLE 8.12.2.2-1
Measurement results that may be transferred
from UE to the LMF (DL-TDoA)

| | UE- | UE- |
|---|---|---|
| Information | assisted | based |
| Latitude/Longitude/Altitude, together with | No | Yes |
| uncertainty shape | | |
| PCI, GCI, ARFCN, PRS resource ID, PRS resource | Yes | No |
| set ID and PRS ID for each measurement | | |
| DL RSTD measurement | Yes | No |
| DL-PRS-RSRP measurement | Yes | No |
| Time stamp of the measurements | Yes | No |
| Time stamp of location estimate | No | Yes |
| Quality for each measurement | Yes | No |
| UE Rx TEG IDs for DL RSTD measurements | Yes | No |
| DL-PRS-RSRPP measurement | Yes | No |
| LOS/NLOS information for UE measurements | Yes | No |
| RSTD Location Error | Yes | No |

TABLE 8.13.2.0-1
Assistance data that may be transferred from gNB to the LMF (UL-TDoA)
Information

PCI, GCI, and TRP IDs of the TRPs served by the gNB
SSB information of the TRPs (the time/frequency occupancy of SSBs)
Geographical coordinates information of the DL-PRS Resources of the
TRPs served by the gNB
TRP type
TRP Location Error
Inter-TRP Synchronization Error

According to embodiments of the invention, a process can be implemented that includes determining a position integrity estimation of the UE 106 at the UE and/or determining a position integrity estimation of the UE 106 at a LMF 100, and, based upon the determined position integrity estimation at the UE 106 and/or at the LMF 100, the position integrity of the UE can be determined. In particular, the determination of the position integrity of the UE 106 can be determined based upon determining the position integrity estimation of the UE at the UE by utilizing integrity requirements and assistance data from the RAN 102/LMF 100, as previously described. Further, determining the position integrity estimation of the UE 106 at the LMF 100 includes utilizing integrity requirements and assistance data from the UE 106 and RAN 102 at the LMF 100 and the position integrity estimation is transmitted to the UE, as previously described.

There are a number of example embodiments described herein.

Example 1 is a method to implement a position integrity operation for a user equipment (UE) in a radio access network (RAN) and a core network, where the method includes determining a position integrity estimation of the UE at the UE; and based upon the determined position integrity estimation at the UE and/or at the LMF, determining the position integrity.

Example 2 is the method of example 1 that may optionally include that determining the position integrity estimation of the UE at the UE includes utilizing integrity requirements and assistance data from the RAN and/or LMF.

Example 3 is the method of example 2 that may optionally include that the assistance data from the RAN and/or LMF includes data facilitating the determination of the position integrity estimation.

Example 4 is the method of example 1 that may optionally include sending, from the UE, integrity requirements and assistance data to the LMF, wherein the position integrity estimation of the UE determined at the LMF includes utilizing the integrity requirements and assistance data from the UE and integrity requirements and assistance data from RAN at the LMF; and receiving, by the UE, the position integrity estimation from the LMF.

Example 5 is the method of example 4 that may optionally include that the assistance data from the UE and from the RAN to the LMF includes data facilitating the determination of the position integrity estimation for the UE at the LMF.

Example 6 is the method of example 1 that may optionally include receiving, by the UE, health status information about a UE or a network component of the RAN supporting the UE in the determination of the position integrity estimation of the UE.

Example 7 is the method of example 6 that may optionally include that determining a position integrity estimation of the UE at the UE comprises receiving an integrity service alert to provide information on whether the service is useable for integrity and a Do Not Use (DNU) flag to indicate whether assistance data associated with the UE or a network component of the RAN supporting the UE in the determination of the position integrity estimation for the UE is determined to not be suitable for computing position integrity, such that if the integrity service alert is issued, and the DNU flag is false, the corresponding assistance data is useable for computing position integrity.

Example 8 is the method of example 7 that may optionally include that the integrity service alert and the DNU flag are applicable for a specific time duration provided in a slot, sub-frame, or frame.

Example 9 is the method of example 8 that may optionally include that assistance data values are pre-defined to a default value of DNU true or false.

Example 10 is the method of example 9 that may optionally include that the assistance data values are pre-defined to a default value of DNU true or false and the integrity service alert switches the DNU value for a specific time duration and switches back to the default value on expiration of the specific time duration.

Example 11 is the method of example 8 that may optionally include that, if an integrity service alert is not received, the DNU is interpreted as false, and when the DNU is received as true, the DNU is held at true until DNU false is or DNU is held at true for a valid time period included in the alert message, and after the time expires, the DNU is transferred back to false.

Example 12 is the method of example 11 that may optionally include that integrity service parameters provide the range of integrity risk (IR) for which associated integrity data assistance of UE and network components of the RAN is considered valid, and the integrity service parameters are transmittable from the LMF to the UE, from network components of the RAN to the LMF, and from the UE to the LMF.

Example 13 is the method of example 1 that may optionally include the UE exchanging location capability and configuration information with one or more of the LMF and a transmission/reception point (TRP) of the RAN; the UE/LMG/TRP exchanging location specific integrity capability and configuration with one or more of the LMF and the TRP of the RAN; the UE sending and/or receiving location specific integrity assistance data; performing location and integrity estimation; and performing locating and integrity signaling and alerts.

Example 14 is a user equipment (UE) to implement a position integrity operation for the UE, the UE in connection with a radio access network (RAN) and a core network including a location management function (LMF), the UE comprising: at least one antenna; at least one radio, wherein the at least one radio is configured to communicate with the RAN including a base station and the core network using the at least one antenna; and at least one processor coupled to the at least one radio, wherein the at least one processor is configured to perform operations comprising: determining a position integrity estimation of the UE at the UE, based upon a determined position integrity estimation at the UE and/or at the LMF.

Example 15 is the UE of example 14 that may optionally include that determining the position integrity estimation of the UE at the UE includes utilizing integrity requirements and assistance data from the RAN and/or LMF.

Example 16 is the UE of example 15 that may optionally include that the assistance data from the RAN and/or LMF includes data facilitating the determination of the position integrity estimation.

Example 17 is the UE of example 14 that may optionally include the UE receiving health status information about the UE or a network component of the RAN supporting the UE or LMF in the determination of the position integrity estimation for the UE.

Example 18 is the UE of example 14 that may optionally include that the UE or LMF in the determination of the position integrity estimation receives an integrity service alert to provide information on whether the service is useable for integrity and a Do Not Use (DNU) flag to indicate if assistance data associated with the UE or a network component of the RAN supporting the UE or LMF in the determination of the position integrity estimation for the UE is determined to not be suitable for computing position integrity, such that if the integrity service alert is issued, and the DNU flag is false, the corresponding assistance data is useable for computing position integrity.

Example 19 is the UE of example 18 that may optionally include that the integrity service alert and the DNU flag are applicable for a specific time duration provided in a slot, sub-frame, or frame.

Example 20 is the UE of example 19 that may optionally include that assistance data values are pre-defined to a default value of DNU true or false.

Example 21 is the UE of example 20 that may optionally include that the assistance data values are pre-defined to a default value of DNU true or false and the integrity service alert switches the DNU value for a specific time duration and switches back to the default value on expiration of the specific time duration.

Example 22 is the UE of example 19 that may optionally include that, if an integrity service alert is not received, the DNU is interpreted as false, and when the DNU is received as true, the DNU is held at true until DNU false is or DNU is held at true for a valid time period included in the alert message, and after the time expires, the DNU is transferred back to false.

Example 23 is the UE of example 22 that may optionally include that integrity service parameters provide the range of integrity risk (IR) for which associated integrity data assistance of UE and network components of the RAN is considered valid, and the integrity service parameters are transmittable from the LMF to the UE, from network components of the RAN to the LMF, and from the UE to the LMF.

Example 24 is a location management function (LMF) system in a core network to implement a position integrity operation for a user equipment (UE) connected to radio access network (RAN) comprising: an interface to send and receive data; a processor coupled to the interface, the processor to perform operations comprising: determining a position integrity estimation of the UE; and sending the determined position integrity estimation of UE to the UE.

Example 25 is the LMF of example 24 that may optionally include that determining the position integrity estimation of the UE at the LMF includes utilizing integrity requirements and assistance data from the UE and RAN at the LMF and the position integrity estimation is transmitted to the UE.

Example 26 is the LMF of example 25 that may optionally include that the assistance data from the UE and the RAN to the LMF includes data facilitating the determination of the position integrity estimation for the UE at the LMF.

Example 27 is the LMF of example 24 that may optionally include that the UE or LMF receives health status information about a UE or a network component of the RAN supporting the UE or LMF in the determination of the position integrity estimation for the UE.

Example 28 is the LMF of example 24 that may optionally include that the UE or LMF in the determination of the position integrity estimation receives an integrity service alert to provide information on whether the service is useable for integrity and a Do Not Use (DNU) flag to indicate if assistance data associated with the UE or a network component of the RAN supporting the UE or LMF in the determination of the position integrity estimation for the UE is determined to not be suitable for computing position integrity, such that if the integrity service alert is issued, and the DNU flag is false, the corresponding assistance data is useable for computing position integrity.

Example 29 is the LMF of example 28 that may optionally include that the integrity service alert and the DNU flag are applicable for a specific time duration provided in a slot, sub-frame, or frame.

Example 30 is the LMF of example 29 that may optionally include that assistance data values are pre-defined to a default value of DNU true or false.

Example 31 is the LMF of example 30 that may optionally include that the assistance data values are pre-defined to a default value of DNU true or false and the integrity service alert switches the DNU value for a specific time duration and switches back to the default value on expiration of the specific time duration.

Example 32 is the LMF of example 31 that may optionally include that, if an integrity service alert is not received, the DNU is interpreted as false, and when the DNU is received as true, the DNU is held at true until DNU false is or DNU is held at true for a valid time period included in the alert message, and after the time expires, the DNU is transferred back to false.

Example 33 is the LMF of example 24 that may optionally include that integrity service parameters provide the range of integrity risk (IR) for which associated integrity data assistance of UE and network components of the RAN is considered valid, and the integrity service parameters are transmittable from the LMF to the UE, from network components of the RAN to the LMF, and from the UE to the LMF.

Example 35 is a UE baseband processor configured to perform one or more operations of claims 1-13.

Example 36 is one or more non-transitory computer readable storage media having instructions stored therein which, when executed by one or more processors of a UE, cause the network equipment to perform one or more of the methods of claims 1-13.

It should be appreciated that the operations of the previously described processes in some embodiments may be performed: at the UE 106 including: a processor, communication interfaces, antenna, a radio, etc.; at the LMF 100 and components of the LMF 100 of the core network including: a processor, communication interfaces, etc.; components of the NG-RAN, base station, gNB 102 etc., including: a processor, communication interfaces, antenna, a radio, etc.—to implement the previously described processes.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

For example, the previously described embodiment operations may be stored as instructions on a non-transitory computer readable medium for execution by a computer (e.g., a UE). The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A method to implement a position integrity operation for a user equipment (UE) in a radio access network (RAN) and a core network comprising:
determining a position integrity estimation of the UE at the UE; and
based upon the determined position integrity estimation at the UE and/or at the LMF, determining the position integrity.

2. The method of claim 1, wherein, determining the position integrity estimation of the UE at the UE includes utilizing integrity requirements and assistance data from the RAN and/or LMF.

3. The method of claim 2, wherein, the assistance data from the RAN and/or LMF includes data facilitating the determination of the position integrity estimation.

4. The method of claim 1, further comprising:
sending, from the UE, integrity requirements and assistance data to the LMF, wherein the position integrity estimation of the UE determined at the LMF includes utilizing the integrity requirements and assistance data from the UE and integrity requirements and assistance data from RAN at the LMF; and
receiving, by the UE, the position integrity estimation from the LMF.

5. The method of claim 4, wherein, the assistance data from the UE and from the RAN to the LMF includes data facilitating the determination of the position integrity estimation for the UE at the LMF.

6-12. (canceled)

13. The method of claim 1, further comprising:
the UE exchanging location capability and configuration information with one or more of the LMF and a transmission/reception point (TRP) of the RAN;
the UE/LMG/TRP exchanging location specific integrity capability and configuration with one or more of the LMF and the TRP of the RAN;
the UE sending and/or receiving location specific integrity assistance data;
performing location and integrity estimation; and
performing locating and integrity signaling and alerts.

14. A user equipment (UE) to implement a position integrity operation for the UE, the UE in connection with a radio access network (RAN) and a core network including a location management function (LMF), the UE comprising:
at least one antenna;
at least one radio, wherein the at least one radio is configured to communicate with the RAN including a base station and the core network using the at least one antenna; and
at least one processor coupled to the at least one radio, wherein the at least one processor is configured to perform operations comprising:
determining a position integrity estimation of the UE at the UE, based upon a determined position integrity estimation at the UE and/or at the LMF.

15-16. (canceled)

17. The UE of claim 14, wherein, the UE is configured to receive health status information about the UE or a network component of the RAN supporting the UE or LMF in the determination of the position integrity estimation for the UE.

18. The UE of claim 17, wherein, the UE or LMF in the determination of the position integrity estimation receives an integrity service alert to provide information on whether the service is useable for integrity and a Do Not Use (DNU) flag to indicate if assistance data associated with the UE or a network component of the RAN supporting the UE or LMF in the determination of the position integrity estimation for the UE is determined to not be suitable for computing position integrity, such that if the integrity service alert is issued, and the DNU flag is false, the corresponding assistance data is useable for computing position integrity.

19. The UE of claim 18, wherein, the integrity service alert and the DNU flag are applicable for a specific time duration provided in a slot, sub-frame, or frame.

20. The UE of claim 19, wherein, assistance data values are pre-defined to a default value of DNU true or false.

21. The UE of claim 20, wherein, the assistance data values are pre-defined to a default value of DNU true or false and the integrity service alert switches the DNU value for a specific time duration and switches back to the default value on expiration of the specific time duration.

22. The UE of claim 19, wherein, if an integrity service alert is not received, the DNU is interpreted as false, and when the DNU is received as true, the DNU is held at true until DNU false is or DNU is held at true for a valid time period included in the alert message, and after the time expires, the DNU is transferred back to false.

23. The UE of claim 14, wherein, integrity service parameters provide the range of integrity risk (IR) for which associated integrity data assistance of UE and network components of the RAN is considered valid, and the integrity service parameters are transmittable from the LMF to the UE, from network components of the RAN to the LMF, and from the UE to the LMF.

24. A location management function (LMF) system in a core network to implement a position integrity operation for a user equipment (UE) connected to radio access network (RAN) comprising:
an interface to send and receive data;
a processor coupled to the interface, the processor to perform operations comprising:
determining a position integrity estimation of the UE; and
sending the determined position integrity estimation of UE to the UE.

25-26. (canceled)

27. The LMF of claim 24, wherein, the UE or LMF receives health status information about a UE or a network component of the RAN supporting the UE or LMF in the determination of the position integrity estimation for the UE.

28. The LMF of claim 27, wherein, the UE or LMF in the determination of the position integrity estimation receives an integrity service alert to provide information on whether the service is useable for integrity and a Do Not Use (DNU) flag to indicate if assistance data associated with the UE or a network component of the RAN supporting the UE or LMF in the determination of the position integrity estimation for the UE is determined to not be suitable for computing position integrity, such that if the integrity service alert is issued, and the DNU flag is false, the corresponding assistance data is useable for computing position integrity.

29. The LMF of claim 28, wherein, the integrity service alert and the DNU flag are applicable for a specific time duration provided in a slot, sub-frame, or frame.

30. The LMF of claim 29, wherein, assistance data values are pre-defined to a default value of DNU true or false.

31. The LMF of claim 30, wherein, the assistance data values are pre-defined to a default value of DNU true or false and the integrity service alert switches the DNU value for a specific time duration and switches back to the default value on expiration of the specific time duration.

32-34. (canceled)
